(19) United States
(12) Patent Application Publication
(10) Pub. No.: US 2007/0200730 A1
(43) Pub. Date: Aug. 30, 2007

(54) INTEGRATED TRAFFIC SIGNAL, SIGN AND INFORMATION DISPLAY DEVICE

(75) Inventor: Sung Ku Kang, Seoul (KR)

Correspondence Address: SHERIDAN ROSS PC, 1560 BROADWAY, SUITE 1200, DENVER, CO, 80202, US

(73) Assignee: WOO JEON GREEN CO., LTD., Seoul (KR)

(21) Appl. No.: 11/679,039

(22) Filed: Feb. 26, 2007

(30) Foreign Application Priority Data
Feb. 27, 2006 (KR) 10-2006-0018778

(51) Int. Cl. G08G 1/095; G09F 9/33

(52) U.S. Cl. 340/907; 340/815.45

(57) ABSTRACT

An integral traffic signal, sign and information display device is comprised of LED array combined with traffic signal unit, traffic sign unit and traffic information unit, each unit having several pixels in a matrix pattern, each pixel being comprised with red, green and blue LED; traffic signal driver, traffic sign driver and traffic information driver for operating the red, green and blue LIED of each unit; controller for controlling each driver so that each unit the corresponding color; and communication unit receiving the traffic information transmitted from the traffic information center and transferring the traffic information to the controller. Various traffic boards can be made into a single board nice and neat. With even single device, much traffic information can be offered to the driver and the pedestrian.

### CROSS-REFERENCE TO RELATED APPLICATION

This application claims priority to and the benefit of Korean Patent Application No. 10-2006-0018778 filed with the Korean Intellectual Property Office on Feb. 27, 2006, the entire content of which is incorporated herein by reference.

### BACKGROUND OF THE INVENTION

1. Field of the Invention

The present invention is an integrated traffic signal, sign and information display device, and mote particularly an integrated traffic signal, sign and information display device which is comprised of a LED array combined with a traffic signal unit, a traffic sign unit and a traffic information unit on a LED array, each unit having several pixels in a matrix pattern, each pixel being comprised with red, green and blue LED

2. Description of the Prior Art

The road is classified as follows according to its usage and configuration: (1) surface street (2) driveway (3) pedestrian mall (4) green way (5) overpass (6) underground street.

Devices of traffic information, which are provided on the above streets, contain a traffic light, various traffic signs (warning sign, intersection, joined road, curved road, regulation sign, information and direction signs, and condition sign etc.)

The traffic light is classified into a pedestrian traffic light and a vehicle traffic light, and furthermore various traffic signs are provided.

FIG. 1 shows a street post having a traffic signal light and a traffic sign according to the prior art. The street post 1 is installed at the center of the road or the edge of the road to install the traffic light on it. A horizontal supporter for traffic sign 2 is fixed to the street post 1, on which the traffic lights 3 and the time elapse display light 6 are installed. A horizontal supporter for traffic sign 4 is fixed to the street post 1 at a different height to the other supporter 2, on which various traffic signs 5 are installed.

Since various traffic lights and traffic signs have been installed in a complicated manner, even the driver having many years experience must check many traffic lights and traffic signs when she/he is a stranger in the street. The drivers may encounter the difficult situation where they can't find the needed information.

To solve the problem, the traffic light using LED is disclosed in Korean Utility Model Registration No 20-0165216, which is shown in FIG. 2.

In the conventional traffic light, the single traffic light 7 has a thin film transistor LED 8 by which the color blue, yellow, red and additional blue arrow can be displayed. Under the command of a traffic light control system, a predetermined color becomes gradually larger at a certain place. At the same time, the color displayed at the previous time becomes gradually smaller. Depending on the present displaying color and the previous displaying color; the information, such as the crossing, and time displaying “do not crossing/passing” for the car or the pedestrian, can be clearly delivered. However, a great deal of various information can not be displayed since the traffic light, the traffic sign and the traffic information can not be installed on the single street post.

Furthermore, the driver and the pedestrian can see the traffic light at night since the traffic light is emitted by a bulb. The traffic sign is covered by nightglow paint instead of the use of the bulb, and can be only seen when light from the street light and the headlight of the car is projected toward the traffic sign.

However, it is computed that there are many numbers of traffic accident cases during day time, but there is a much high mortality rate during night time. It is required that the traffic sign can be clearly seen even where the reflection angle of the head light is out of the way (e.g. curved road) and the road has poor reflection rate (e.g. heavy fog area near lake).

Therefore, the night driver can get the information of the road by the traffic sign emitting by itself. It is necessary that the number of traffic accident occurring at night time can be reduced, and also the number of casualties can be reduced in the traffic accident.

Under the revision of the road traffic regulation in 2005, the light emitting traffic safety sign should be installed at the following places: the frequent fog load, the road having high accident rate and high potential rate, and poor visual range.

The road traffic regulation says that the color of the light emitting traffic safety sign should be changed to the follows; background of warning, safety and direction sign is in non-gloss black: in the character and the symbol, the warning is in yellow, and the regulatory and direction is in white. The color of the conventional sign was as following; warning sign: a yellow background and black symbol, regulatory sign: a white background and black symbol, and directory sign: a blue background and white symbols.

### SUMMARY OF THE INVENTION

It is the object of the present invention to provide the integrated traffic signal, sign and information display device to solve various problems being exposed in the prior art.

It is the object of the present invention to provide the integrated traffic signal, sign and information display device, in which three different traffic lights (led, blue and yellow) can be substituted with single light, and the signal can display a large size even if the size of the single light is smaller than the previous ones.

It is the object of the present invention to provide the integrated traffic signal, signal and information display device, in which the traffic sign emits by itself, and the driver can clearly read the sign where the street light and the headlight do not flash on the traffic sign at night time.

In order to accomplish the above objects, an integrated traffic signal, sign and information display device is comprised of:

light emitting diode (LED) array combined with traffic signal unit, traffic sign unit and traffic information unit, each unit having several pixels in a matrix pattern, each pixel being comprised with red, green and blue LED;

traffic signal driver, traffic sign driver and traffic information driver for operating the red, green and blue LED of the traffic signal unit, traffic sign unit and traffic information unit, respectively;

controller for controlling the traffic signal driver so that the traffic signal unit of the LED array displays the corresponding traffic signal, for controlling the traffic sign driver 30 so that the traffic sign unit displays the corresponding traffic sign, and for controlling the traffic information driver under the traffic information being received from the traffic information center so that the traffic information unit displays the correct traffic information; and

communication unit receiving the traffic information transmitted from the traffic information center and transferring the traffic information to the controller.

In accordance with a preferred feature of this invention, the traffic signal unit has a circle element, which displays various colors (red, green, and blue), and each LED (red, green and blue) of the circle element is emitted according to the duty ratio with respect to the corresponding color, which displays the requested color.

In accordance with a preferred feature of this invention, the traffic signal unit is comprised of a circle element, which displays various colors with respect to the corresponding traffic signal; a character element represents the color of tile circle element by the character; and a remaining time display element displays the remaining time of the corresponding traffic signal in direct proportion to the remaining time.

In accordance with a preferred feature of this invention, the traffic sign unit has a circle element, which displays various colors (red, green, and blue), and each LED (red, green and blue) of the circle element is emitted according to the duty ratio with respect to the corresponding color, which displays the requested color.

In accordance with a preferred feature of this invention, an integrated traffic signal, sign and information display device is comprised of:

light emitting diode (LED) array combined with a pedestrian signal unit, a time elapse display unit, and a destination display unit, each unit having several pixels in a matrix pattern, each pixel being comprised of red, green and blue LED;

a pedestrian signal driver, a time elapse sign driver and a destination display driver for operating the red, green and blue LED of the pedestrian signal unit, the time elapse sign unit and the destination display unit, respectively; and

controller for controlling the pedestrian signal driver so that the pedestrian signal unit displays the corresponding pedestrian signal, for controlling the time elapse sign driver so that the time elapse display unit displays the remaining time for the crossing period, and for controlling the destination display driver so that the destination display unit displays the destination name.

In accordance with a preferred feature of this invention, the character displays in the pedestrian signal unit, the character displays the color with respect to the signal for the pedestrian.

In accordance with a preferred feature of this invention, the time elapse display unit further has a remaining time display element which is represented by a bar, the bar is displayed in proportion to the remaining time.

In accordance with a preferred feature of this invention, on the remaining time display element, the color bar representing the Do cross is displayed in proportion to the cross allowing time, while the color bar representing the Do not cross is displayed in the inverse proportion to the cross allowing time.

### BRIEF DESCRIPTION OF DRAWINGS

The above and other objects, features and other advantages of the present invention will be more clearly understood from the following detailed description taken in conjunction with the accompanying drawings, in which

FIG. 1 shows a street post having a traffic signal light and a traffic sign according to a prior art;

FIG. 2 is a traffic signal using LED displaying blue, yellow, red and additional green arrow according to a prior art;

FIG. 3 is a block diagram illustrating the components of the integrated traffic signal, sign and information display device according to the present invention;

FIG. 4a is one embodiment showing yellow at the traffic signal unit of the LED array;

FIG. 4b is the time chart illustrating the mark time ratio of each LED representing color yellow in single pixel that is comprised of red, green, and blue LED;

FIG. 5a is an embodiment showing green and arrow for displaying a left turn sign on a traffic signal unit of the LED array;

FIG. 5b is the time chart illustrating the mark time ratio of each LED representing green and arrow for displaying a left turn sign on a traffic signal unit of the LED array;

FIG. 5c is the time chart illustrating the mark time ratio of each LED representing a white arrow for displaying a left turn sign on a traffic signal unit of the LED array;

FIG. 6 is the traffic sign unit of the LED array according to the present invention, in which the maximum safe speed sign and No cargo truck allowed sign;

FIG. 7 is an embodiment showing traffic information on the traffic information unit of the LED array;

FIG. 8 is a block diagram illustrating the integrated pedestrian signal, time elapse, and destination display device; and

FIG. 9 is an embodiment illustrating the road information sign of the general load according to the inventive integral traffic signal, sign and information display device.

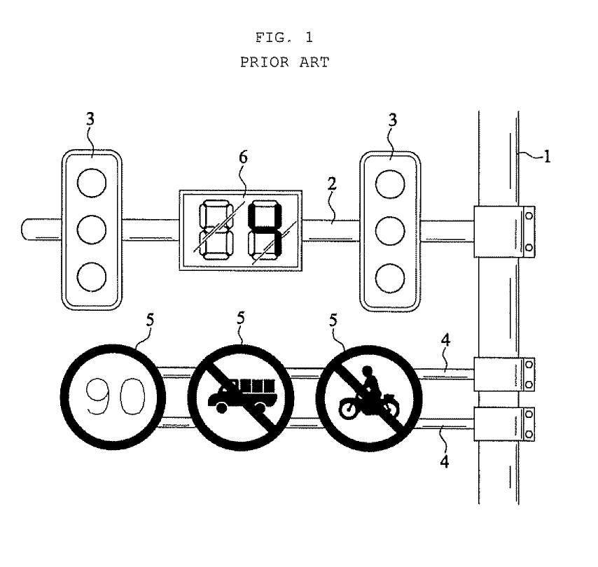

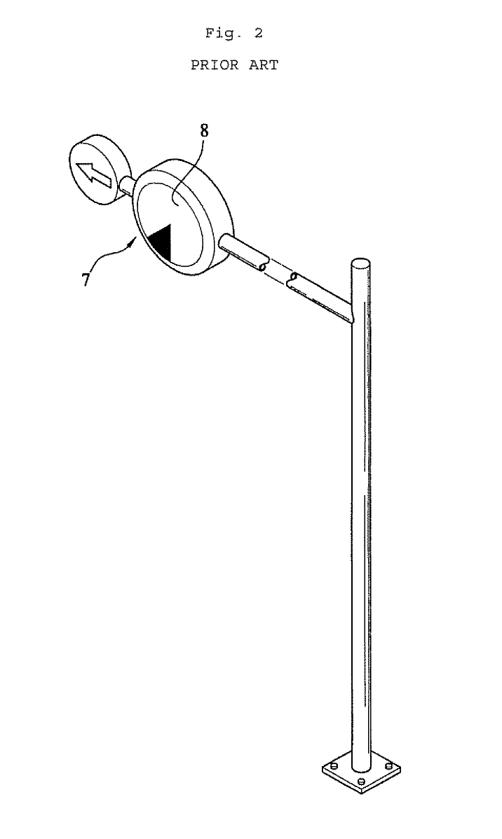

### DESCRIPTION OF THE PREFERRED EMBODIMENTS

This invention will be described further by the way of exemplary embodiments with reference to the accompanying drawings.

FIG. 3 shows a block diagram illustrating the components of the integrated traffic signal, sign and information display device according to the present invention.

The integrated traffic signal, sign and information display device is comprised of light emitting diode (LED) array 10 combined with traffic signal unit 11, traffic sign unit 12 and traffic information unit 13, each unit having several pixels in a matrix pattern, each pixel being comprised with red, green and blue LED; and traffic signal driver 20, traffic sign driver 30 and traffic information driver 40 for operating the red, green and blue LED of the traffic signal unit 11, traffic sign unit 12 and traffic information unit 13, respectively.

Furthermore, the integrated traffic signal, sign and information display device is comprised of a controller 50 by which the traffic signal driver 20 is controlled so that the traffic signal unit 11 of the LED array 10 displays the corresponding traffic signal, the traffic sign driver 30 is controlled so that the traffic sign unit 12 displays the corresponding traffic sign, and the traffic information driver 40 is controlled under the traffic information being received from the traffic information center so that the traffic information unit 13 displays the correct traffic information.

Furthermore, the integrated traffic signal, sign and information display device is comprised of a communication unit 60 receiving the traffic information transmitted from the traffic information center and transferring the traffic information to the controller 50.

In the LED array 10, each pixel is comprised of a red, a green, and a blue LED, and several pixels are arranged in a matrix pattern. A single pixel can display various colors depending on the mark time ratio of each different color LED (red, green and blue).

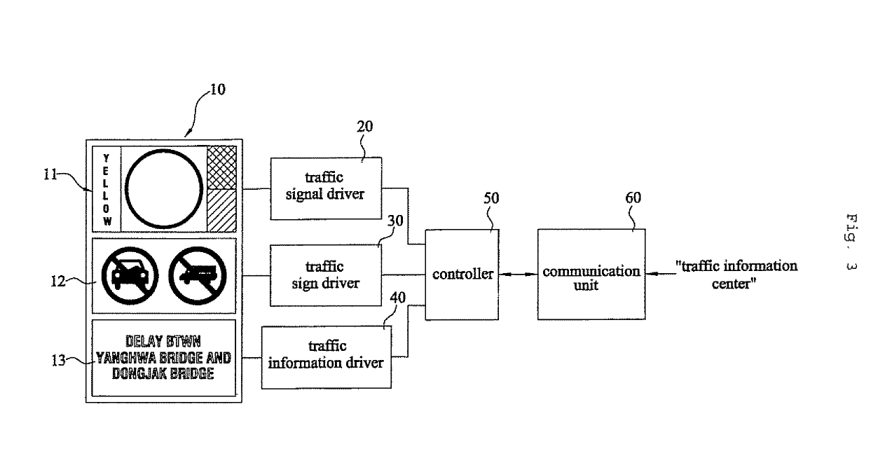

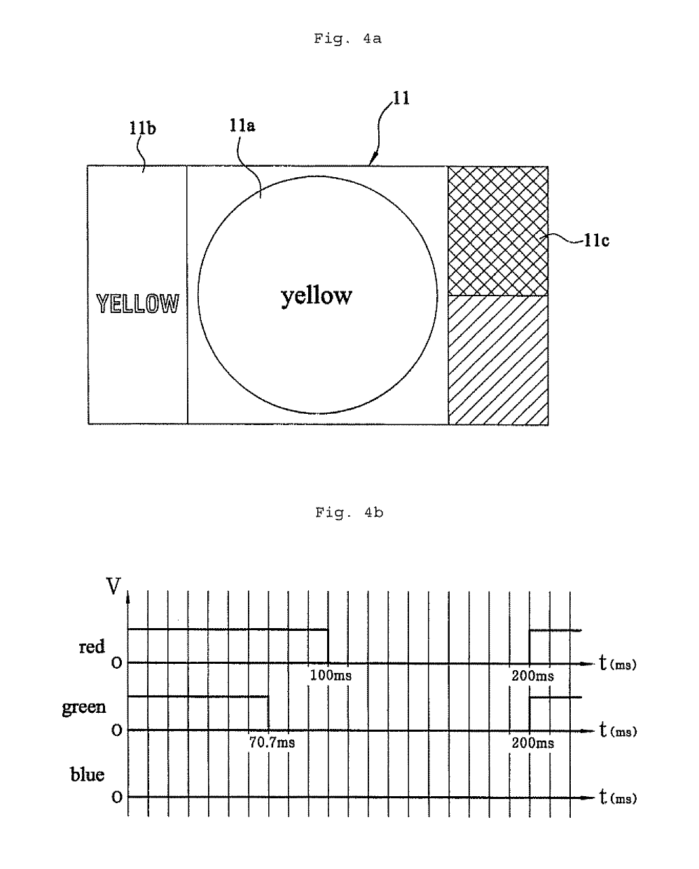

FIG. 4a illustrates one embodiment showing yellow at the traffic signal unit of the LED array.

At the traffic signal unit 11 having several pixels in a matrix pattern, a circle element 11a is established, which displays various colors (red, yellow, and blue) and left turn signal arrow. In the circle element 11a, each LED (red, green and blue) of the pixel is emitted according to the duty ratio with respect to the corresponding color, which displays the requested color.

A character element 11b is formed at the left side of the circle element 11a, in which the color of the traffic signal is represented by the character. For instance, when the circle element 11a displays the color yellow, the character “yellow” is displayed on the character element 11b. Furthermore, the remaining time display element 11c is formed at the right side of the circle element 11a, which displays the remaining time of the corresponding traffic signal. For instance, in the case that the color yellow is displayed on the circle element 11a, the oblique line of the remaining time display element 11c is represented in yellow. The color area of the remaining time display element 11c is displayed in direct proportion to the remaining time.

FIG. 4b shows the time chart illustrating the mark time ratio of each LED representing the color yellow in single pixel that is comprised of red, green, and blue LED.

The red LED emits by the pulse signal having 100% duty ratio. The green LED emits by the pulse signal ratio having 70.7% duty ratio. The blue LED emits by the pulse signal having zero % duty ratio. Therefore, single pixel represents color yellow. Therefore, in the case that the traffic signal unit 11 of the LED array 10 displays the color yellow, each led, green, and blue LED of several pixels, which composes of the circle element 11a, the character element 11b, and the remaining time display element 11c, emits by the duty ratio corresponding to the requested color. Thus, each element displays the color red, blue, and yellow. At the same time, the LEDs for representing the character “yellow” of the character element 11b are turned off to display the color black. Also, the oblique line of the remaining time display element 11c is represented as yellow, but the LEDs of the cross hatched area of the remaining time display element 11c are turned off to display the color black.

In the case the integral integrated traffic signal, sign and information display device is installed at a pedestrian crossing, the traffic signal unit 11 of the LED array 10 displays the color blue so that a car can pass through. After cars pass through at a certain time, the traffic signal unit 11 displays the color red so that the car must stop. Then pedestrians can cross the crossing.

When it allows the car to pass through, the circle element 11a of the traffic signal unit 11 displays the color yellow foe a certain period as shown in FIGS. 4a and 4b . After the elapsed period, the color yellow is changed to the color blue, by which it avoids an accident caused by a sudden acceleration of the car; in the case of just the red and blue lights.

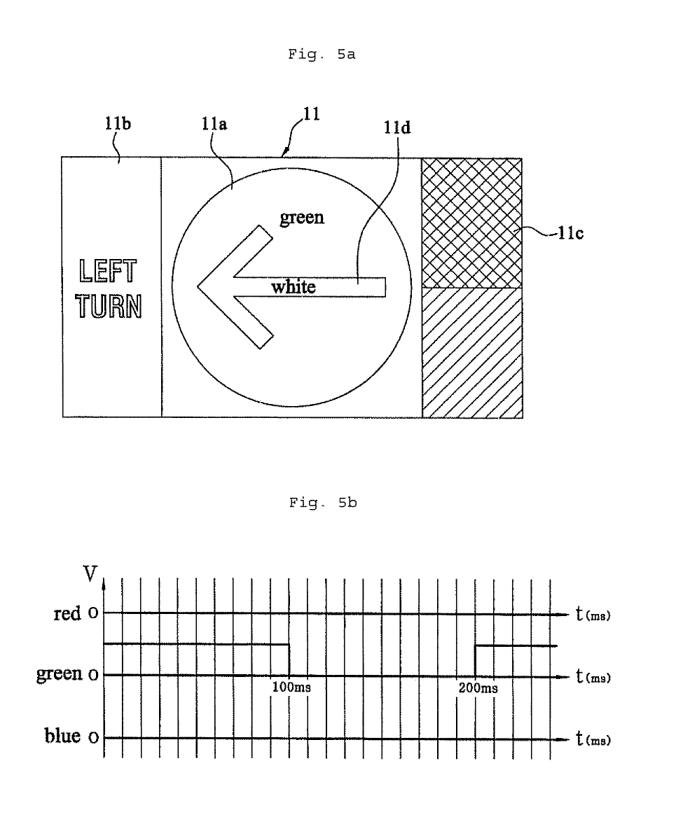

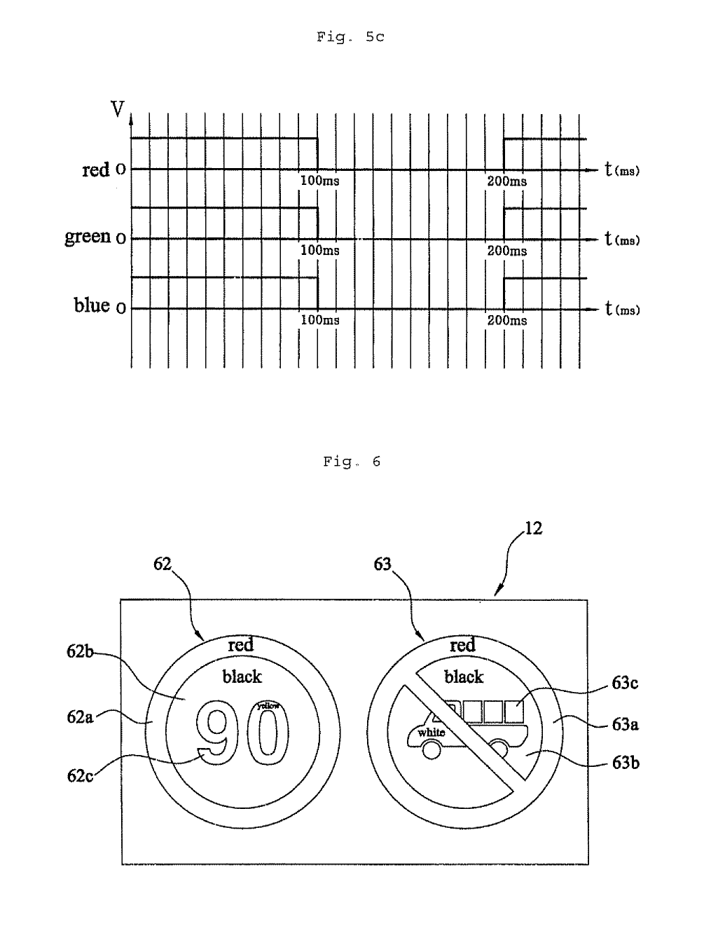

Furthermore, in the left turn signal, as shown in 5a, in the circle element 11a of the traffic element 11, only green LED is turn on for the duty ratio 100% as shown in FIG. 5b, and the circle element 11a displays the color green. The left turn arrow 11d in the center of the circle element 11a displays the color white by turning on the red, green and blue LEDs for the duty ratio 100% as shown in FIG. 5c.

At the same time, the LEDs in the character “left turn” of the character element 11b turn off to display the color black. The oblique line of the remaining time display element 11c is represented as green. Also, the cross hatched portion of the remaining time display element 11c is turned off to display the color black.

The traffic sign unit 12 of the LED array 10 can display various traffic sign symbols, for instance, intersection, jointed road, curved road, regulation sign, information and direction signs, and condition sign.

FIG. 6 illustrates the traffic sign unit of the LED array according to the present invention, which include the maximum safe speed sign and No cargo truck allowed sign.

Only red LEDs of the pixel which represent the red circle band 62a of the maximum safe speed sign 62 are emitted at the traffic sign unit 12. The pixels in the background 62b of the circle band 62a are armed off to display the color black. The pixels corresponding to the speed FIG. 62c emit the color yellow by controlling the duty ratio of the red and green LEDs.

The pixels corresponding to the red circle band 63a of the No cargo truck allowed sign 63 emit in the color red. The pixels in the background 63b of the sign 63 are turned off to display the color black. The pixels corresponding to the cargo truck sign 63c emit the color white by turning on all LEDs of red, green and blue.

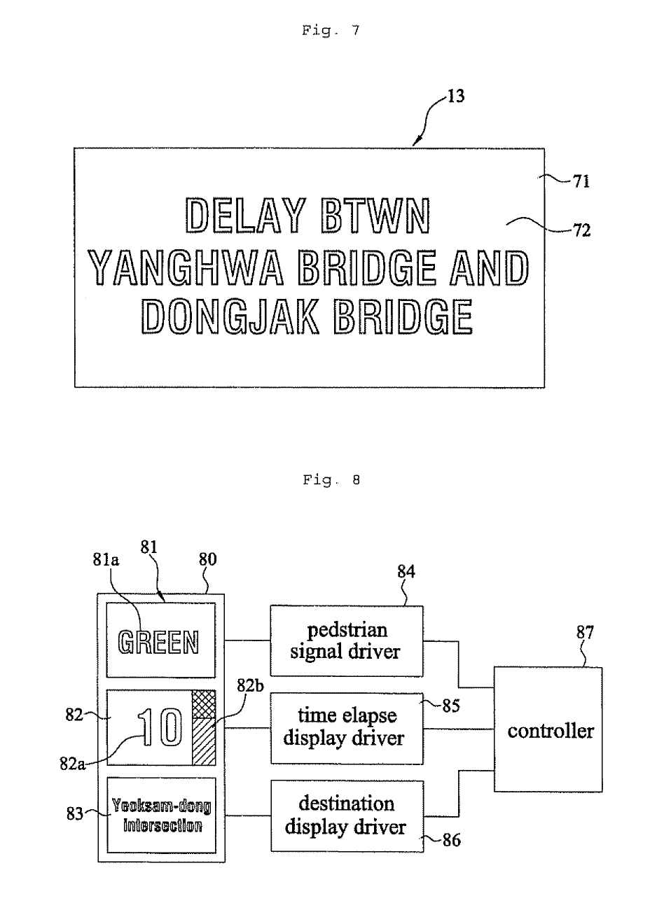

The traffic information unit 13 of the LED array 10 receives in real time the traffic information from the traffic information center through the communication unit 60 and display the corresponding information. For instance, as shown in FIG. 7, in the case the traffic information like “delay btwn Yanghwa bridge and Dongjak bridge” is received, the pixels of the background 71 of the traffic information unit 13 are turned off to display the color black. The pixels corresponding to the character 72 emit the color yellow by controlling the ditty ratio of the red and green LEDs.

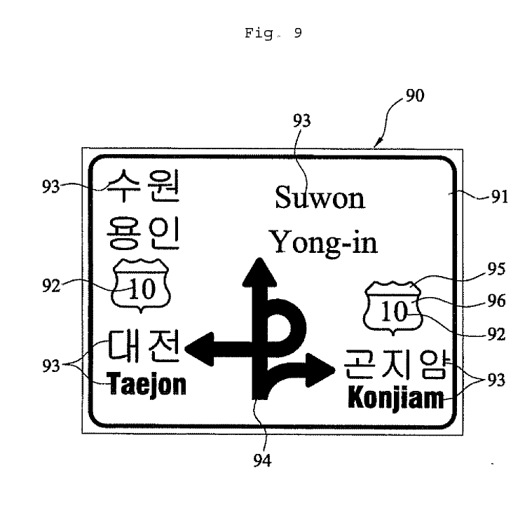

FIG. 8 shows a block diagram illustrating the integrated pedestrian signal, time elapse, and destination display device.

The integrated pedestrian signal, time elapse, and destination display device is comprised of light emitting diode (LED) array 80 combined with a pedestrian signal unit 81, a time elapse display unit 82, and a destination display unit 83, each unit having several pixels in a matrix pattern, each pixel being comprised of red, green and blue LED.

The integrated pedestrian signal, time elapse, and destination display device is furthermore comprised of a pedestrian signal driver 84, a time elapse sign driver 85 and a destination display driver 86 for operating the red, green and blue LED of the pedestrian signal unit 81, the time elapse sign unit 82 and the destination display unit 83, respectively.

The integrated pedestrian signal, time elapse, and destination display device is furthermore comprised of a controller 87 by which the pedestrian signal driver 84 is controlled for the pedestrian signal unit 81 to display the corresponding pedestrian signal, the time elapse sign driver 85 is controlled for the time elapse display unit 82 to display the remaining time for the crossing period, and the destination display driver 86 is controlled for the destination display unit 83 to display the destination name.

In the LED array 80, each pixel is comprised of a red, green, and blue LED, and several pixels are arranged in a matrix pattern. The LED array has the following classifications: the pedestrian signal unit 81, the time elapse display unit 82, the destination display unit 83, each unit display the pedestrian signal, the time for crossing a road, and the name of road, respectively.

When the green signal at the pedestrian crossing should be displayed, the green LED in tile pixel of the pedestrian signal unit 81 emits the color green, which represents that the pedestrian can cross the road.

Furthermore, the character “green” 81a displays in the center of the pedestrian signal unit 81, of which the display method is the same as the previous explanation in the traffic signal unit 11.

At the same time, the time elapse display unit 82 displays the remaining time to cross as shown in the FIG. 82a. This operation is the same as the previous description regarding the traffic signal unit 11. At the right side of the time elapse display unit 82 is provided a remaining time display element 82b which is represented by a bar. The remaining time display element 82b is displayed in proportion to tile remaining time. It gives the pedestrian the information whether the pedestrian should cross the road quickly, run, or stay behind the cross line to wait for the next safe signal.

In the bar symbol of the remaining time element 82b, the height of the bar can represent the time the pedestrian can cross, which is displayed in the color green. At the same time, the color representing the Do not cross (for example, red) display as a bar in the inverse proportion to the height of the yellow bar.

That is, the green representing the cross enabling is displayed in the whole area of the bat of the remaining time element 82b. Along the time passing, the green bat becomes shorter in proportion to the remaining time, while the red bar becomes longer in the inverse proportion to the remaining time.

Successively, the Do not cross should be given to the pedestrian, the red LED of the pixel in the pedestrian sign unit 81 emits so as to display the red sign representing no crossing for the pedestrian.

Furthermore, the destination display unit 83 is provided below the time elapse display unit 82, which display the name of the streets around the road. The pedestrian can confirm the place where he/she stands.

The road information sign is comprised of (1) local road: rectangular shaped board with a green background and blue letters or symbols (2) general national road: rectangular shaped board with a blue background and white letters or symbols (3) tourism area sign: rectangular shaped board with a brown background and white letters or symbols.

The type of the road information sign is categorized as follows: (1) boundary sign: representing the boundary of an administrative district (2) destination sign: representing the distance to the destination (3) direction sign: representing direction, e.g. advance notice and just in place notice (4) route sign: representing main lane and branched lane (5) the rest sign: administrative area, facilities information, detour; yield and climbing lane.

FIG. 9 shows the embodiment illustrating the road information sign of the general road according to the inventive integral traffic signal, sign and information display device.

The road information sign comprises the LED array 90 having several pixels. Each pixel is comprised of a red, a green, and a blue LED, and several pixels are arranged in a matrix pattern. The local road number, name of destination, direction, and branched route, etc. are displayed on the LED array 90.

As this embodiment shows the local road, the background 91 is displayed in green, and only green LED of the corresponding pixel emits. Since the local road number 92, the Korean and English name of destination 93, and the branched route 94 should be displayed with the pixel corresponding to white, using the red, green and blue LED. Thus, each LED emits at 100% duty ratio, respectively, to display the white. To emphasize the view of the local road number 92, the band 95 having a wave shape should be displayed in red so that only red LED corresponding to the pixel emits. On the circle band 96 surrounding the local road number 92, only blue LED corresponding to the pixel emits to display the blue.

As described above, according to the integral traffic signal, sign and information display device of this invention, the traffic signal, the traffic sign, and the traffic information can be integrated with single device. Various traffic boards can be made into a single board nice and neat. With even single device, much traffic information can be offered to the driver and the pedestrian.

What is claimed is:

1. An integrated traffic signal, sign and information display device comprising:
light emitting diode (LED) array combined with traffic signal unit, traffic sign unit and traffic information unit, each unit having several pixels in a matrix pattern, each pixel being comprised with red, green and blue LED;
traffic signal driver, traffic sign driver and traffic information driver for operating the red, green and blue LED of the traffic signal unit, traffic sign unit and traffic information unit, respectively;
controller for controlling the traffic signal driver so that the traffic signal unit of the LED array displays the corresponding traffic signal, for controlling the traffic sign driver so that the traffic sign unit displays the corresponding traffic sign, and for controlling the traffic information driver under the traffic information being received from the traffic information center so that the traffic information unit displays the correct traffic information; and
communication unit receiving the traffic information transmitted from the traffic information center and transferring the traffic information to the controller.

2. The integrated traffic signal, sign and information display device according to claim 1 wherein the traffic signal unit has a circle element, which displays various colors (red, green, and blue), and each LED (red, green and blue) of the circle element is emitted according to the duty ratio with respect to the corresponding color, which displays the requested color.

3. The integrated traffic signal, sign and information display device according to claim 1 wherein the traffic sign unit has a circle element, which displays various colors (red, green, and blue), and each LED (red, green and blue) of the circle element is emitted according to the duty ratio with respect to tile corresponding color, which displays the requested color.

4. An integrated traffic signals sign and information display device comprising:
light emitting diode (LED) array combined with a pedestrian signal unit, a time elapse display unit, and a destination display unit, each unit having several pixels in a matrix pattern, each pixel being comprised of red, green and blue LED;
a pedestrian signal driver, a time elapse sign driver and a destination display driver for operating the red, green and blue LED of the pedestrian signal unit, the time elapse sign unit and the destination display unit, respectively; and
controller for controlling the pedestrian signal driver so that the pedestrian signal unit displays the corresponding pedestrian signal, for controlling the time elapse sign driver so that the time elapse display unit displays the remaining time for the crossing period, and for controlling the destination display driver so that the destination display unit displays the destination name.

5. The integrated traffic signal, sign and information display device according to claim 1 wherein the traffic signal unit is comprised of a circle element, which displays various colors with respect to the corresponding traffic signal; a character element represents the color of the circle element by the character; and a remaining time display element displays the remaining time of the corresponding traffic signal in direct proportion to the remaining time.

6. The integrated traffic signal, sign and information display device according to claim 4 wherein the character displays in the pedestrian signal unit, the character displays the color with respect to the signal for the pedestrian

7. The integrated traffic signal, sign and information display device according to claim 4 wherein the time elapse display unit further has a remaining time display element which is represented by a bar, the bar is displayed in proportion to the remaining timer.

8. The integrated pedestrian signal, time elapse, and destination display device according to claim 7 wherein on the remaining time display element, the color bar representing the Do cross is displayed in proportion to the cross allowing time, while the color bar representing the Do not cross is displayed in the inverse proportion to the cross allowing time.
